(19) United States
(12) Patent Application Publication
(10) Pub. No.: US 2014/0262949 A1
(43) Pub. Date: Sep. 18, 2014

(54) METHOD FOR AUTOMATED TEMPERATURE CONTROL OF REACTOR SYSTEM

(71) Applicant: Allan G. Kem, Red Lodge, MT (US)

(72) Inventor: Allan G. Kem, Red Lodge, MT (US)

(21) Appl. No.: 13/846,819

(22) Filed: Mar. 18, 2013

(51) Int. Cl. G05D 23/19; G05B 17/02

(52) U.S. Cl. CPC G05D 23/1932; G05B 17/02
USPC 208/107; 700/30; 703/18

(57) ABSTRACT

Methods of controlling the heat-up and/or cool-down of a reactor system. One method includes collecting data sets for a hydrocracker reactor system at a first heat-up rate, generating a stability detection model of the reactor, modifying the heat-up rate through an operating region where initiation of reactions are expected and where reactions are occurring until the reactor achieves stable operation.

### FIELD

The present invention is generally related to the refining of petroleum hydrocarbons into products of greater utility and higher value as compared to the feedstock by converting high boiling petroleum feedstocks into lower boiling products. The present invention is related to methods of controlling the heat of a hydrocracker reactor system. More specifically, the present invention is related to methods of controlling the heat-up and/or cool-down of a hydrocracker reactor system. The method enables a more efficient and safer start up or shut down of a hydrocracker reactor system than obtainable under the prior art.

### BACKGROUND

Petroleum refineries are finding it necessary to convert increasingly greater proportions of crude to premium fuels. In addition as the world's supply of light sweet crude decreases, refiners are being forced to use poorer quality crude oil feedstocks.

Hydrocracking is a process which has achieved widespread use in petroleum refining for converting various petroleum fractions to lighter and more valuable products, especially gasoline and distillates such as jet fuels, diesel oils and heating oils. In the process, the heated petroleum feedstock is contacted with a catalyst in the presence of hydrogen or a hydrogen donor material.

Generally, a hydrocracker unit in a refinery “cracks” heavier hydrocarbons into lighter hydrocarbons. For example, complex organic molecules (e.g., heavy hydrocarbons, such as gas oils, cycle oils and coker oils) are broken down into simpler molecules (e.g. lighter hydrocarbons, such as gasoline, diesel, jet fuel and naphtha) by the breaking of carbon-carbon bonds. Hydrocracking occurs in one or more reactors at elevated pressures and temperatures and is an exothermic reaction overall. The rate of cracking and the resulting composition of the end products are dependent on variables such as the temperature, pressure, chemical nature of the feed oil and the type and condition of the catalyst. One particular problem associated with hydrocracking is that of a temperature excursion or “runaway”, which can occur in one or more reactor beds of the process, due to the exothermic nature of the reaction.

Typically heated oil and excess hydrogen enter one or more reactor(s) having multiple fixed catalyst beds. The catalyst promotes the cracking and hydrogenation reactions of larger hydrocarbon molecules into lighter molecules. The reaction is exothermic, so the temperature increases as flow passes through each bed.

Between beds, hydrogen quench gas is introduced to cool the reaction mix. In this way, the reactor is a succession of cracking beds followed by quenching. The overall objective is to achieve the desired total amount of cracking (or “conversion”), which is borne out in the downstream fractionation section product spreads. Maximizing unit conversion or throughput typically means operating at one or more quench constraints. These quench constraints can include maximum quench valve position, chosen to assure ample reserve quench should an exothermic excursion occur, and maximum bed temperature rise, which indicates high cracking severity and increased risk of a rapid onset excursion. A number of related process constraints, such as heater limits or hydrogen availability, may also come into play to limit available cracking.

There can be many potential initiators of hydrocracking reactor temperature excursions, such as detailed in the EPA Chemical Accident Investigation Report, Tosco Avon Refinery, Martinez California, November 1998. When an excursion grows out of control or exceeds reactor design temperature limits, the reactor must be depressurized to a flare system. Depressurization may be initiated manually or automatically by the control system.

Depressurization, while a necessary safety function, is extremely undesirable from an operational and economic standpoint. Depressurization brings the prospect of a several-day restart procedure, large thermal and mechanical stresses potentially causing damage to equipment, environmental and community concerns related to flaring, and large total incurred operating cost, often in the range of one million dollars per depressurization event. Therefore, the incentive to maintain temperature control at all times is high.

Excursion events can occur anytime, but are especially common during start-up and other heat-up operations, due to the many non-routine activities taking place, the point of onset of cracking not being precisely known beforehand, and automatic controls, which are designed for operation after final cracking temperatures become established, are often disabled or in manual mode during heat-up operations. It is desirable to have a method of controlling the heat-up operations that will increase efficiency and reduce the risks of an exothermic excursion while maintaining temperature control.

### SUMMARY

Disclosed herein is a safe method to automatically raise temperatures in a reactor system, such as a hydrocracking process, from relatively low non-cracking temperatures to higher desired cracking temperatures. This operation has not previously been automated in industry, even though it is uniquely hazardous to carry out manually without automatic safeguards. It is uniquely hazardous to carry out manually because, as temperatures are raised, the temperature at which the reaction begins, and the severity or suddenness with which it begins, are unknown beforehand, while at the same time there is large economic incentive to achieve on-specification production as rapidly as possible. This combination commonly results in overly fast heat-up rates and sudden unexpected onset of cracking, leading to an excursion and potential depressurization event, with safety and cost implications.

An embodiment of the invention provides a time-efficient method to automatically raise temperatures in a hydrocracking reactor system from relatively low non-cracking temperatures to higher desired cracking temperatures. By monitoring the actual rate of cracking, as evidenced by the temperature rise in each reactor bed and related temperature conditions, the heat-up rate can be optimized for a safe and efficient heat-up profile. This has the potential to convert hundreds of hours per year of costly off-specification operation to valuable on-specification production, and has the feature of being both faster and safer.

Moreover, the invention facilitates a safe and time-efficient heat-up by also monitoring process stability and automatically pausing the heat-up operation if instability is detected, until the base-layer controls re-establish process stability. This assures that the reactor temperature controls remain in control of reactor temperatures throughout the heat-up operation, and are available to respond adequately as cracking or an excursion begins.

The invention further enables safe and time-efficient heat-up by allowing existing base-layer and advanced temperature controls and safeguards, such as bed outlet and average bed temperature controls as described by Kern in Hydrocracker Controls, Hydrocarbon Processing Journal, October, 2012, to remain in effect during the heat-up operation. During conventional manual (non-automatic) heat-up operations, some or all of the automatic temperature controls and safeguards (if any), including the base-layer temperature controls, are often not in effect, due to being in manual mode or bypassed, so that there is often no or only a limited automatic control response to prevent or respond to an excursion during heat-up operations.

The invention also can be used to minimize reactor cool-down times, saving additional operational hours. Safety and efficiency incentives are typically lower during this mode of operation (cool-down as opposed to heat-up), but concerns still exist, due to the presence of non-routine operating activities potentially leading to excursion incidents, the possibility of automatic controls being disabled (in manual mode or bypassed), and the need, as always, to carry out operations in as time-efficient a manner as possible.

The invention also applies to “temperature recovery” operations, which are heat-up operations not associated with unit startup. For example, a process upset or equipment trip can lead to loss of tens or hundreds of degrees of reactor temperature, and so heat-up operations must be undertaken to re-establish cracking conditions, even though these are not strictly speaking “startup” operations.

The invention is implemented by integration with traditional reactor average bed temperature (ABT) controls, also known as weighted average bed temperature (WABT) controls, and bed-outlet temperature controllers, as described by the inventor in Hydrocracker Controls, Hydrocarbon Processing Journal, October, 2012. Traditional ABT controls are designed primarily for steady-state control after final cracking conditions have been established, and for small gradual temperature adjustments, and have several limitations that prevent their usage for large or rapid temperature changes, such as during start-up. By adding variable rate and stability assurance features to the ABT controls, the invention extends the usage of ABT controls to a broad range of temperature change operations, i.e. to heat-up, cool-down and recovery, instead of only steady-state operation, while at the same time increasing the safety and efficiency of these operations, and leveraging additional value from the base-layer, bed outlet, and ABT reactor temperature controls.

An embodiment of the present invention is a method of temperature control of a reactor that includes collecting first data sets for a reactor while the reactor is in a first operating region where no reactions are expected and at a first heat-up rate and generating a stability detection model of the reactor using the first data sets. Upon reaching a first reactor set-point temperature, modifying the heat-up rate from the first heat-up rate to a second heat-up rate and collecting second data sets for the reactor while the reactor is in a second operating region where initiation of reactions are expected and at the second heat-up rate. A stability detection model of the reactor is generated using the second data sets. When the second data sets indicate the initiation of reactions and entering a third operating region, modifying the heat-up rate from the second heat-up rate to a subsequent heat-up rate. Subsequent data sets for the reactor are collected while the reactor is in the third operating region where reactions are occurring and at the subsequent heat-up rate. The stability detection model of the reactor is modified using the subsequent data sets. The subsequent heat-up rate is modified as needed until the reactor achieves final stable operating conditions. If the stability detection model of the reactor detects an unstable condition within the reactor, the heat-up rate is temporarily adjusted to zero until stability is achieved. The temperature differentials across catalyst beds within the reactor can indicate the initiation of reactions within the reactor. Optionally the reactor is a hydrocracker and optionally the first heat-up rate is greater than the second heat-up rate.

An alternate embodiment is a computer program product that contains instructions to model the temperature control of a reactor during start-up of a hydrocracker, the instructions which, when executed by at least one processor, causes the processor to perform a method. The method includes extracting a dataset from a database, the dataset comprising a first start-up temperature rate, a second start-up temperature rate and an algorithm determining a desired start-up rate from temperature data and temperature differentials across catalyst beds within a hydrocracking reactor. The method includes collecting first data sets for a reactor while the reactor is in a first operating region where no reactions are expected and at a first heat-up rate and generating a stability detection model of the reactor using the first data sets. Upon reaching a first reactor set-point temperature, modifying the heat-up rate from the first heat-up rate to a second heat-up rate and collecting second data sets for the reactor while the reactor is in a second operating region where initiation of reactions are expected and at the second heat-up rate. A stability detection model of the reactor is generated using the second data sets, when the second data sets indicate the initiation of reactions and entering a third operating region, modifying the heat-up rate from the second heat-up rate to a subsequent heat-up rate. Subsequent data sets for the reactor are collected while the reactor is in the third operating region where reactions are occurring and at the subsequent heat-up rate and the stability detection model of the reactor is modified using the subsequent data sets. The subsequent heat-up rate is modified until the reactor achieves stable operation. If the stability detection model of the reactor detects an unstable condition within the reactor, the heat-up rate is temporarily adjusted to zero until stability is achieved. The temperature differentials across catalyst beds within the reactor can indicate the initiation of reactions within the reactor. Optionally the reactor is a hydrocracker and optionally the first heat-up rate is greater than the second heat-up rate.

An alternate embodiment is a computer system that includes a processor, a memory coupled to the processor and a display device coupled to the processor. The memory stores a program that, when executed by the processor, causes the processor to collect first data sets for a reactor while the reactor is in a first operating region where no reactions are expected and at a first heat-up rate and generate a stability detection model of the reactor using the first data sets. Upon reaching a first reactor set-point temperature, modify the heat-up rate from the first heat-up rate to a second heat-up rate and collect second data sets for the reactor while the reactor is in a second operating region where initiation of reactions are expected and at the second heat-up rate and generate a stability detection model of the reactor using the second data sets. When the second data sets indicate the initiation of reactions and entering a third operating region, modify the heat-up rate from the second heat-up rate to a subsequent heat-up rate, collect subsequent data sets for the reactor while the reactor is in the third operating region where reactions are occurring and at the subsequent heat-up rate and generate a stability detection model of the reactor using the subsequent data sets. The subsequent heat-up rate is modified until the reactor achieves stable operation. If the stability detection model of the reactor detects an unstable condition within the reactor, the heat-up rate is temporarily adjusted to zero until stability is achieved. A reactor temperature and heat-up rate is displayed on a display device. The temperature differentials across catalyst beds within the reactor can indicate the initiation of reactions within the reactor. Optionally the reactor is a hydrocracker and optionally the first heat-up rate is greater than the second heat-up rate.

A further embodiment is a non-transitory computer-readable medium storing instructions that, when executed by a processor, cause the processor to causes the processor to collect first data sets for a reactor while the reactor is in a first operating region where no reactions are expected and at a first heat-up rate and generate a stability detection model of the reactor using the first data sets. Upon reaching a first reactor set-point temperature, modify the heat-up rate from the first heat-up rate to a second heat-up rate and collect second data sets for the reactor while the reactor is in a second operating region where initiation of reactions are expected and at the second heat-up rate and generate a stability detection model of the reactor using the second data sets. When the second data sets indicate the initiation of reactions and entering a third operating region, modify the heat-up rate from the second heat-up rate to a subsequent heat-up rate, collect subsequent data sets for the reactor while the reactor is in the third operating region where reactions are occurring and at the subsequent heat-up rate and generate a stability detection model of the reactor using the subsequent data sets. The subsequent heat-up rate is modified until the reactor achieves stable operation. If the stability detection model of the reactor detects an unstable condition within the reactor, the heat-up rate is temporarily adjusted to zero until stability is achieved. A reactor temperature and heat-up rate is displayed on a display device. The temperature differentials across catalyst beds within the reactor can indicate the initiation of reactions within the reactor. Optionally the reactor is a hydrocracker and optionally the first heat-up rate is greater than the second heat-up rate.

### BRIEF DESCRIPTION OF DRAWINGS

FIG. 1 is schematic of a hydrocracking process in common use in the prior art.

FIG. 2 is a schematic of a typical distributed control system (DCS) architecture in common use in the prior art.

FIG. 3 is a schematic of a multi catalyst bed hydrocracking reactor and controls, including initial design controls, bed outlet and bed average (ABT) controls and temperature rate and stability controls as in the present invention.

FIG. 4 is graphical presentation of a rate generator function as can be used in the present invention.

FIG. 5 is a flow chart showing how the variable rate and stability assurance features of the present invention can integrate with traditional reactor average bed temperature (ABT) controls.

FIG. 6 is a schematic of a computer system that can be used with the present invention.

FIG. 7 is a flow chart of an embodiment of the present invention.

### DETAILED DESCRIPTION

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil refining industry, the systems and methods of the present invention are not limited thereto and may also be applied to other industries to achieve similar results.

The present invention meets the above needs and overcomes one or more deficiencies in the prior art by providing systems and methods for controlling the temperature of a reactor system during reactor temperature change operations.

The present invention includes methods of controlling the temperature of a hydrocracker reactor system during start-up, shut-down, recovery, and other related reactor temperature change operations. More specifically, the present invention is generally related to methods of controlling the heat-up and/or cool-down of a hydrocracker reactor system. Under final cracking conditions, typical hydrocracking operating procedures restrict reactor temperature change rates to circa two to five degrees Fahrenheit per hour (2-5° F./hour), to assure process stability is maintained and to avoid unexpected and uncontrolled excursions. Traditional reactor temperature controls are designed for this mode of operation and have several limitations that prevent their usage during startup, shutdown or recovery operations, when temperatures must be changed by tens or hundreds of degrees. During these operations, the rate restriction is not feasible, as it can equate to the unnecessary loss of many hours of potential valuable on-specification operation. Nonetheless, during these operations, the eventual point of onset of cracking or potential for an excursion to occur is not precisely known, so that while a higher rate of temperature change is needed, safeguards to prevent or control a potential excursion are also needed. This problem is addressed by the present invention.

### System Description

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on by, the processing unit. By way of example, and not limitation, the computing unit includes an operating system, application programs, other program modules, and program data.

The components shown in the memory may also be included in other removable/nonremovable, volatile/nonvolatile computer storage media. For example only, a hard disk drive may read from or write to nonremovable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above therefore, store and/or carry computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like.

These and other input devices are often connected to the processing unit through the client interface that is coupled to a system bus, but may be connected by other interface and bus structures, such as a parallel port or a universal serial bus (USB). A monitor or other type of display device may be connected to the system bus via an interface, such as a video interface. In addition to the monitor, computers may also include other peripheral output devices such as speakers and printer, which may be connected through an output peripheral interface.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer or tablet device, a cellular telephone, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

The terms “couple” or “couples,” as used herein are intended to mean either an indirect or a direct connection. Thus, if a first device couples to a second device, that connection may be through a direct connection, or through an indirect electrical connection via other devices and connections. The term “communicatively coupled” as used herein is intended to mean coupling of components in a way to permit communication of information therebetween. Two components may be communicatively coupled through a wired or wireless communication network, including but not limited to Ethernet, LAN, fiber optics, radio, microwaves, satellite, and the like. Operation and use of such communication networks is well known to those of ordinary skill in the art and will, therefore, not be discussed in detail herein.

FIG. 6 illustrates in greater detail an embodiment of a computer system 600 which may be used to calculate and control the temperature of a reactor system, and may also be used to calculate probability values indicative of the occurrence of temperature excursion events. The computer system 600 comprises a processor 602, and the processor couples to a display device 610 and a main memory 604 by way of a bridge device 606. It is on the display device 610 that the various temperature and heat up rate values may be displayed, or the probability of the occurrence of a temperature excusion event may be displayed. Moreover, the processor 602 may couple to a long-term storage device 608 (e.g., a hard drive, solid state disk, memory stick, optical disc) by way of the bridge device 606. Programs executable by the processor 602 may be stored on the storage device 608, and accessed when needed by the processor 602. In some cases, the programs are copied from the storage device 608 to the main memory 604, and the programs are executed from the main memory 604. Thus, the main memory 604, and storage device 608 shall be considered computer-readable storage mediums.

Although many other internal components of the computing unit are not shown, those of ordinary skill in the art will appreciate that such components and their interconnection are well known.

Process control systems, such as distributed or scalable process control systems like those used in hydrocarbon refining processes, typically include one or more process controllers communicatively coupled to each other, to at least one host or operator workstation and to one or more field devices via analog, digital or combined analog/digital buses. The field devices, which may be, for example, valves, valve positioners, switches and transmitters (e.g., temperature, pressure and flow rate sensors), perform functions within the process such as opening or closing valves and measuring process parameters. The process controller receives signals indicative of process measurements made by the field devices and/or other of information pertaining to the field devices, uses this information to implement a control routine and then generates control signals which are sent over the buses to the field devices to control the operation of the process. Information from the field devices and the controller is typically made available to one or more applications executed by the operator workstation to enable an operator to perform any desired function with respect to the process, such as viewing the current state of the process, modifying the operation of the process, etc.

Information from the field devices and the process controllers is typically made available to one or more other hardware devices such as operator workstations, maintenance workstations, engineer workstations, personal computers, handheld devices, data historians, report generators, centralized databases, etc., to enable an operator, maintenance or engineering person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, diagnosing problems or hardware failures within the process plant, etc.

These and other diagnostic and optimization applications are typically implemented on a system-wide basis in one or more of the operator, maintenance or engineering workstations, and may provide preconfigured displays to the personnel regarding the operating state of the process plant, or the devices and equipment within the process plant. Typical displays include alarming displays that receive alarms generated by the process controllers or other devices within the process plant, control displays indicating the operating state of the process controllers and other devices within the process plant, maintenance displays indicating the operating state of the devices within the process plant, etc. Likewise, these and other diagnostic applications may enable an operator, maintenance or engineering person to retune a control loop or to reset other control parameters, to run a test on one or more field devices to determine the current status of those field devices, to calibrate field devices or other equipment, or to perform other problem detection and correction activities on devices and equipment within the process plant.

### Process Description

While these various applications and tools are very helpful in identifying and correcting problems within a process plant, these diagnostic applications are generally configured to be used only after a problem has already occurred within a process plant and, therefore, after an abnormal situation already exists within the plant. Unfortunately, an abnormal situation may exist for some time before it is detected, identified and corrected using these tools, resulting in the suboptimal performance of the process plant for the period of time during which the problem is detected, identified and corrected. In many cases, a control operator will first detect that some problem exists based on alarms, alerts or poor performance of the process plant. The operator will then notify the maintenance or engineering personnel of the potential problem, who may or may not detect an actual problem and may need further prompting before actually running tests or other diagnostic applications, or performing other activities needed to identify the actual problem. Once the problem is identified, the maintenance personnel may need to order parts, special procedures may need to be planned and scheduled, etc., all of which may result in a significant period of time between the occurrence of a problem and the correction of that problem, during which time the process plant runs in an abnormal situation generally associated with the sub-optimal operation of the plant and often with a decreased level of reliability and safety, for example is good control is compromised due to the problem.

Additionally, many process plants can experience an abnormal situation which results in significant costs or damage within the plant in a relatively short amount of time. For example, some abnormal situations can cause significant damage to equipment, the loss of raw materials, or significant unex peeled downtime within the process plant if these abnormal situations exist for even a short amount of time. Thus, merely detecting a problem within the plant after the problem has occurred, no matter how quickly the problem is corrected, may still result in significant loss or damage within the process plant. As a result, it is desirable to try to prevent abnormal situations from arising in the first place, instead of simply trying to react to and correct problems within the process plant after an abnormal situation arises.

While the above techniques may be applied to a variety of process industries, refining is one industry in which abnormal situation prevention is particularly applicable. Moreover, abnormal situation prevention is particularly applicable to hydrocrackers as used in the refining industry, due to the severe process conditions involved (elevated temperature and pressure), the exothermic reaction, the many potential initiators of temperature excursions, and the economic and safety implications of a runaway reaction and depressurization event.

As used herein, the term “cracking temperature” refers to the temperature at which the cracking reaction takes place in a particular reactor. In a hydrocracking reactor, the cracking reaction takes place at elevated temperature and pressure, in the presence of a catalyst. Non-cracking temperatures refers to relatively low temperatures at which the cracking reaction does not occur. Cracking temperatures refers to higher temperatures at which the cracking reaction is ongoing. As reactor temperatures are raised, many factors affect the onset of cracking, the strength of the reaction, and the potential for a “runaway reaction” or “excursion”, especially many aspects of chemical nature of the feed oil and the type and condition of the catalyst, and the presence and effectiveness of automatic controls to provide reliable temperature control during all modes of operation.

As used herein, the term “excursion” refers to a sudden or rapid rise in reactor bed temperatures caused by an increase in reaction rate and the exothermic nature of the reaction. Due to the non-linear nature of exothermic reactions (as a guideline, the rate of any chemical reaction doubles for each ten degree centigrade increase in reaction temperature), automatic controls often take time or fail to bring an excursion under control. An unchecked excursion can eventually reach depressure conditions, sometimes in a matter of minutes or seconds. An excursion can also be called a runaway reaction or exotherm.

As used herein, the term “depressure conditions” refers to reactor system temperature and pressure design limits that should not be exceeded. Depressurization may be initiated automatically or manually based on high reactor temperatures or related depressure conditions. In this situation, the reactor system is vented to a flare system. While this is a necessary safeguard from a safety point of view, it is generally to be avoided from an operational point of view, because it means loss of production, economic cost, process impact on related refinery units, thermal and mechanical stresses to equipment, community and environmental concerns (due to flaring), etc.

As used herein, the term “On-specification/Off-specification” refers to whether or not the final hydrocracking unit products meet product specifications, or instead must be recycled or reprocessed. Until final cracking conditions are established, some or all products typically remain off-specification.

As used herein, the term “Availability” refers to the percentage of time the hydrocracking unit is in operation and making on-specification products. This is often used as a measure of overall refining efficiency, as well as a measure of successful operation, maintenance, engineering and management of the hydrocracking unit.

As used herein, the term “base-layer controls” refers to the low-level controllers that maintain basic control, stability and operation of the process. Base-layer controls reside in the process controller in FIG. 2. Supervisory controls, residing in the supervisory computer, are not base-layer controls, because they are not always available, and are generally for higher level advanced control or optimization. Base-layer controls are also known as regulatory controls or the regulatory control layer. Base-layer controls, in some contexts, may include field instrumentation and safety system controls.

As used herein, the term “Safety system controls” refers to control functions that help assure basic safety of a process, but which are independent of the DCS and base-layer. Auto-depressure systems are often implemented as safety system controls (although they are also sometimes implemented as DCS controls).

As used herein, the term “Temperature rise” refers to a measure of the amount of cracking ongoing in a reactor bed. The hydrocracking reaction overall is exothermic, so the bed outlet temperature is greater than the bed inlet temperature, by an amount related to the amount of cracking. The temperature rise is typically calculated as the average bed outlet temperature minus the average bed inlet temperature. Often, for various reasons, the rise may be calculated slightly differently, for example using the maximum outlet temperature minus the minimum inlet temperature, or using a subset of the temperature measurements. This is also sometimes referred to as the “temperature delta” or “bed delta”.

As used herein, the term “Severity” refers to the amount or strength of the ongoing exothermic hydrocracking reactions, or to the relative temperature necessary to achieve the target amount of cracking (as catalyst ages or becomes contaminated, higher temperatures are necessary to achieve the same amount of cracking).

As used herein, the term “Conversion” refers to the amount of feed oil that is converted to final products, usually expressed as a percent. In many contexts, conversion can be similar in meaning to severity, cracking, and temperature rise.

As used herein, the term “Excursion temperature” refers to the calculated excursion temperature as the current value of a temperature measurement minus its recent historical value, for example, a 30 or 60 minute filtered or rolling average value. This difference reflects any short-term temperature rise, i.e. an excursion.

FIG. 1 illustrates an example of a hydrocracking process. The process 100 consists of a hydrocracking section 102 and a fractionation section 104. In this example a feed stream 110 is heated in heater 114 and enters a first reactor 120 and travels through multiple beds 120 (a-n) where the cracking and hydrogenation reactions occur. The feed stream includes the heavy hydrocarbon oils to be cracked, as well as hydrogen, which may be mixed with the oil feed or may be fed separately and may have an additional separate heater. Make-up hydrogen 112 also is fed to the reactor system to replenish the consumed hydrogen and to maintain system pressure. The process can have multiple reactors illustrated by a second reactor 130 that can likewise have multiple reactor beds 130 (a-n). Additional hydrogen is also usually injected at the second reactor but is not shown. Reaction products exit the reactors and can be cooled in exchanger 134 and liquids and vapors (mainly excess hydrogen) are separated in separator 140. Hydrogen is recycled via line 142 and a recycle compressor (not shown) back to the reactors. The liquid products exiting the separator 140 can be heated in heater 144 and fed to fractionator 150 where various products of differing boiling points can be separated 151-154, such as LPG, naphtha, jet fuel and diesel fuel. Fractionator bottoms 155 are often recycled to the reactors or to a second stage reactor of similar design. In this way, some hydrocracking units are designed to convert nearly 100% of the feed stream. Usually, a similarly designed hydro-treating reactor (not shown) precedes the hydro-cracking reactors, in order to remove feed contaminants that can otherwise poison and deactivate the hydrocracking catalysts. Quench hydrogen is injected between each to cool the reaction mix (this is not shown, but is shown in FIG. 3).

FIG. 2 shows a simplified distributed control system (DCS) implementation for the hydrocracker reactor controls in the present invention. This diagram is typical for most refinery DCS control systems, although the network can grow quite large for large complex units and refineries. Base-layer controls reside primarily in the process controllers. Safety functions reside primarily in the safety controllers. And advanced controls reside in either the process controllers or the supervisory computers. Operations, maintenance and engineering are carried out through a variety of workstation types.

FIG. 3 illustrates an example of a hydrocracking reactor and control system, including initial design controls ((TC-IN-1, TC-IN-2, and TC-IN-n), bed outlet and ABT controls as per reference 1 (TC-OUT-1, TC-OUT-2, TC-OUT-n, and TC-ABT), and variable rate and stability assurance controls as in the present invention (TY-STAB and TY-RATE). Hydrocracking reactors are typically designed, built and started up with only the initial design bed inlet temperature control loops (TC-IN-1, TC-IN-2, and TC-IN-n), which adjust the quench gas flow into each bed. Bed outlet, ABT or other “advanced” controls are typically added, to varying extents, often over the course of many years, after the hydrocracking unit is initially brought on line. The controls in the present invention would be added in concert with, or subsequent to, ABT, bed outlet, and/or multivariable controls (MPC).

In the present invention, a Rate Generator calculates a rate at which the ABT controls will adjust the base-layer temperature controls, in order to bring actual ABT equal to a target value or setpoint. Prior to the present invention, ABT controls have been limited to temperature change rate limits of ca. 2-5° F./hour, so that ABT controls are not usable during startup, shutdown or recovery operations, when temperatures must be raised or lowered by tens or hundreds of degrees. Consequently, ABT controls, when available, still are not usable during operations when faster rates are desired, the onset of cracking must be monitored, and ongoing stability needs to be ensured. The rate generator in this invention dynamically adjusts the ABT rate based on ongoing process conditions to meet operating needs for safe and efficient temperature changes, taking into account these and other factors.

In the present invention, a Stability Detector determines if it is safe and prudent to continue changing temperatures. If conditions are stable, then it is generally considered safe and prudent to proceed. If conditions are unstable, then the change is paused until stable conditions are re-established, by action of the base-layer controls and natural settling of the process. Stability can be detected in a number of ways. Non-limiting examples include: (a) any temperature controller with a high deviation (difference between a set point and the actual temperature) indicates instability. This includes all bed inlet and outlet controllers and related heater controllers; (b) any high bed excursion temperature. In this case, the high excursion setting is dynamically related to the ongoing calculated heat-up rate, for example equal to the ongoing rate plus ca. 5° F. or 10° F. High excursion temperature would normally also manifest as a high bed outlet controller deviation. (c) High, low or high rate-of-change of other key process parameters, such as process pressures or flow rates.

The Rate Generator, Stability Detection, and Pausing on Instability, and their method of integrating with traditional ABT controls via the rate parameter, are the specific parts of the present invention

As used herein, the term “Average Bed Temperature (ABT) Controls” refers to controls that adjust the base-layer temperature controls to achieve desired overall temperature and related process constraints. ABT controls may be implemented using multivariable control technology (MPC) or a custom program as described by Kern in Hydrocracker Controls, Hydrocarbon Processing Journal, October, 2012. The ABT controls adjust the base-layer temperature control setpoints to achieve the target or setpoint ABT. Hydrocracking reactor temperatures are primarily managed based on ongoing ABT and temperature rise, i.e. if conversion is lower or higher than desired, the ABT setpoint or target will be raised or lowered, respectively, subject to other constraints, such as the ongoing temperature rise and quench constraints. In the invention, the ABT controls have the additional features of a variable rate parameter (the maximum rate at which the base-layer controller setpoints will be changed) and “pausing”, or holding the setpoints constant, whenever instability is detected, until base-layer stability is re-established.

FIG. 4 is a graphical representation of how the variable rate can be calculated to meet operating needs for safe and efficient reactor system temperature changes. FIG. 4 has three segments:

In segment I, temperatures are low such that no cracking is expected. The heat-up rate is the maximum for time efficiency, because temperatures are too low for cracking to be a concern. Typical maximum heat-up rates in the oil refining industry are 20° F. to 50° F. per hour (an initial rate of 25F per hour is shown in FIG. 4). Typical reactor temperatures for this segment in industrial hydrocrackers are below 400° F. to 500° F. Normally, the maximum temperature measurement throughout the reactor would be used to establish if the reactor is in segment I or segment II.

In segment II, reactor temperatures are high enough for cracking to potentially begin, but it has not yet begun, as indicated by the lack of a temperature rise across the beds. Under these operating conditions, a more moderated heat-up rate is indicated, typically in the range of 10° F. to 20° F. per hour, in order to assure stable control and operation when cracking begins. Typical reactor temperatures for this segment in industrial hydrocrackers are 450° F. to 600° F., depending on the particular unit and conditions.

In segment III, cracking has begun, as indicated by the non-zero temperature rise across the beds. The bed with the maximum temperature rise would normally be used to establish if the reactor is in segment II or segment III. In segment III, the heat-up rate tapers from the moderate rate of segment II, to the final rate associated with final target operating conditions. Hydrocracker operating procedures normally call for maximum temperature setpoint changes under cracking conditions of 2-5° F./hour. This is the final rate in segment III. As heat-up progresses from segment II, into cracking conditions, and on to final operating conditions, the rate tapers from the moderate rate to the final rate, based on the ongoing temperature rise. For example, using a linear taper, as temperature rise increases from 5° F. to 20° F., the rate decreases linearly from 20° F./Hour to 2° F./Hour. This is shown graphically in FIG. 4.

In all segments, if instability is detected, the heat-up rate will pause, meaning the rate will be temporarily set to a value of zero so that the temperature control setpoint will remain unchanged, until stable conditions become re-established.

FIG. 5 is a flow chart 500 showing how the rate calculation 510 and stability assurance 520 features of the invention integrate with traditional average bed temperature (ABT) controls 530. FIG. 5 illustrates the integration of a variable rate and stability assurance features that are achieved by the present invention as opposed to a traditional ABT control. A typical ABT will use a constant minimum rate, which renders it unsuitable for large temperature change operations. ABT controls generally raise and lower the base-layer bed temperature setpoints to achieve the target ABT value, at a fixed maximum rate of ca. 2-5° F./hour. The ABT controls 530 also further adjust individual bed temperatures to control or optimize other important constraints, such as maximum quench valve position, maximum bed temperature rise, and bed-to-bed temperature profile. In FIG. 5, the ABT controls 530 use a dynamically calculated rate that is much larger when safe to do so based on reactor temperatures and subject to stability assurance. As implemented in a control system, the algorithm depicted by FIG. 5 would normally be executed at a frequency of ca. once per second to once per minute.

The rate generator 510 can determine whether the maximum temperature observed in the reactor system has reached the initial cracking temperature, and if not then the heat up rate can be at a maximum, such as for example 20-50° F./hour. If the maximum temperature observed in the reactor system has reached the initial cracking temperature then the heat up rate can be at a more moderate rate, such as for example 10-20° F./hour. If the maximum temperature rise observed in the reactor system is greater than a predetermined rate, such as 5° F., then the heat up rate can be reduced proportionately. If the maximum temperature rise observed in the reactor system is greater than a predetermined value, such as 10-20° F., then the heat up rate can be reduced to the predetermined heat up rate, for example 2-5° F. The stability detection 520 monitors whether there exists a high deviation on any base-layer controller or a high excursion temperature. The stability assurance 530 will determine the actual heat up rate, or ramp rate, which can be zero if the stability detection 520 observes an unstable condition. If a stable condition is observed then the calculated rate from rate generator 510 can be sent to the ABT controls 540. The ABT controls 540 then sends setpoints to the base-layer controllers and can adjust base-layer setpoints to achieve the target ABT value. The ABT controls 540 can further adjust the base-layer setpoints to manage constraints, such as maximum quench valve opening, maximum bed temperature rise, or bed-to-bed temperature profile of a reactor system.

FIG. 7 is a flow chart that illustrates an embodiment of the rate calculation mechanism. On a periodic basis (700), typically once per minute, process stability is checked (710). If the process is unstable, the rate is paused, or set to zero (720). If the process is stable, reactor temperatures are checked (730). If any reactor bed temperature rise is greater than ca. 5° F., indicating that the cracking reaction has begun, then the rate is calculated according to Segment III of the rate algorithm (FIG. 4) (740). If not, and any reactor temperature exceeds the moderate level, typically in the range of 400-500° F., then the rate is calculated according to Segment II (750). Otherwise, the rate is set according to Segment I. The selected rate is then written to the reactor ABT controls (760).

While the invention has been described herein in terms of embodiments, these embodiments are not to be taken as limiting the scope of the invention. It is deemed to be within the scope of the present invention that each embodiment disclosed herein is usable with each and every other embodiment disclosed herein and that all embodiments disclosed herein are combinable with each other.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A method of temperature control of a reactor comprising:
collecting first data sets for a reactor while the reactor is in a first operating region where no reactions are expected and at a first heat-up rate;
generating a stability detection model of the reactor using the first data sets;
upon reaching a first reactor set-point temperature, modifying the heat-up rate from the first heat-up rate to a second heat-up rate;
collecting second data sets for the reactor while the reactor is in a second operating region where initiation of reactions are expected and at the second heat-up rate;
generating a stability detection model of the reactor using the second data sets;
when the second data sets indicate the initiation of reactions and entering a third operating region, modifying the heat-up rate from the second heat-up rate to a subsequent heat-up rate;
collecting subsequent data sets for the reactor while the reactor is in the third operating region where reactions are occurring and at the subsequent heat-up rate;
generating a stability detection model of the reactor using the subsequent data sets;
modifying the subsequent heat-up rate until the reactor achieves stable operation;
wherein if the stability detection model of the reactor detects an unstable condition within the reactor, the heat-up rate is temporarily adjusted to zero until stability is achieved.

2. The method of claim 1, wherein the reactor is a hydrocracker.

3. The method of claim 1, wherein the first heat-up rate is greater than the second heat-up rate.

4. The method of claim 1, wherein temperature differentials across catalyst beds indicate the initiation of reactions within the reactor.

5. A method of temperature control of a hydrocracker reactor comprising:
collecting a plurality of first data sets for the hydrocracker while the hydrocracker is in a first operating region where no reactions are expected and at a first heat-up rate, each of the plurality of first data sets generated from temperature differentials across catalyst beds in a reactor of the hydrocracker;
generating a stability model of the hydrocracker for each temperature difference variable using the plurality of first data sets;
upon reaching a reactor set-point temperature indicating entering a second operating region wherein reactions are expected to begin, modifying the heat-up rate from the first heat-up rate to a second heat-up rate;
collecting a plurality of second data sets for the hydrocracker while the hydrocracker is in a second operating region;
modifying the heat-up rate from the second heat-up rate to a subsequent heat-up rate when the second data sets indicate the initiation of reactions within the reactor and entering a third operating region;
modifying the subsequent heat-up rate until the reactor achieves stable operation.

6. The method of claim 5, wherein temperature differentials across catalyst beds indicate the initiation of reactions within the reactor.

7. The method of claim 5, wherein the first heat-up rate is greater than the second heat-up rate.

8. A computer program product comprising instructions to model the temperature control of a reactor during start-up of a hydrocracker, the instructions which, when executed by at least one processor, causes the processor to perform a method comprising:
extracting a dataset from a database, the dataset comprising a first start-up temperature rate, a second start-up temperature rate and an algorithm determining a desired start-up rate from temperature data and temperature differentials across catalyst beds within a hydrocracking reactor;
collecting first data sets for a reactor while the reactor is in a first operating region where no reactions are expected and at a first heat-up rate;
generating a stability detection model of the reactor using the first data sets;
upon reaching a first reactor set-point temperature, modifying the heat-up rate from the first heat-up rate to a second heat-up rate;
collecting second data sets for the reactor while the reactor is in a second operating region where initiation of reactions are expected and at the second heat-up rate;
generating a stability detection model of the reactor using the second data sets;
when the second data sets indicate the initiation of reactions and entering a third operating region, modifying the heat-up rate from the second heat-up rate to a subsequent heat-up rate;
collecting subsequent data sets for the reactor while the reactor is in the third operating region where reactions are occurring and at the subsequent heat-up rate;
generating a stability detection model of the reactor using the subsequent data sets;
modifying the subsequent heat-up rate until the reactor achieves stable operation;
if the stability detection model of the reactor detects an unstable condition within the reactor, the heat-up rate is temporarily adjusted to zero until stability is achieved.

9. The method of claim 8, wherein the reactor is a hydrocracker.

10. The method of claim 8, wherein the first heat-up rate is greater than the second heat-up rate.

11. The method of claim 8, wherein temperature differentials across catalyst beds indicate the initiation of reactions within the reactor.

12. A computer system comprising:
a processor;
a memory coupled to the processor;
a display device coupled to the processor;
the memory storing a program that, when executed by the processor, causes the processor to:
collect first data sets for a reactor while the reactor is in a first operating region where no reactions are expected and at a first heat-up rate;
generate a stability detection model of the reactor using the first data sets;
upon reaching a first reactor set-point temperature, modify the heat-up rate from the first heat-up rate to a second heat-up rate;
collect second data sets for the reactor while the reactor is in a second operating region where initiation of reactions are expected and at the second heat-up rate;
generate a stability detection model of the reactor using the second data sets;
when the second data sets indicate the initiation of reactions and entering a third operating region, modify the heat-up rate from the second heat-up rate to a subsequent heat-up rate;
collect subsequent data sets for the reactor while the reactor is in the third operating region where reactions are occurring and at the subsequent heat-up rate;
generate a stability detection model of the reactor using the subsequent data sets;
modify the subsequent heat-up rate until the reactor achieves stable operation;
if the stability detection model of the reactor detects an unstable condition within the reactor, the heat-up rate is temporarily adjusted to zero until stability is achieved; and
display a reactor temperature and heat-up rate on a display device.

13. The computer system of claim 12, wherein the reactor is a hydrocracker.

14. The computer system of claim 12, wherein the first heat-up rate is greater than the second heat-up rate.

15. The computer system of claim 12, wherein temperature differentials across catalyst beds indicate the initiation of reactions within the reactor.

16. A non-transitory computer-readable medium storing instructions that, when executed by a processor, cause the processor to:
collect first data sets for a reactor while the reactor is in a first operating region where no reactions are expected and at a first heat-up rate;
generate a stability detection model of the reactor using the first data sets;
upon reaching a first reactor set-point temperature, modifying the heat-up rate from the first heat-up rate to a second heat-up rate collect second data sets for the reactor while the reactor is in a second operating region where initiation of reactions are expected and at the second heat-up rate;
generate a stability detection model of the reactor using the second data sets;
when the second data sets indicate the initiation of reactions and entering a third operating region, modifying the heat-up rate from the second heat-up rate to a subsequent heat-up rate;
collect subsequent data sets for the reactor while the reactor is in the third operating region where reactions are occurring and at the subsequent heat-up rate;
generate a stability detection model of the reactor using the subsequent data sets;
modifying the subsequent heat-up rate until the reactor achieves stable operation;
if the stability detection model of the reactor detects an unstable condition within the reactor, the heat-up rate is temporarily adjusted to zero until stability is achieved; and
display a reactor temperature and heat-up rate on a display device.

17. The non-transitory computer-readable medium of claim 16, wherein the reactor is a hydrocracker.

18. The non-transitory computer-readable medium of claim 16, wherein the first heat-up rate is greater than the second heat-up rate.

19. The non-transitory computer-readable medium of claim 16, wherein temperature differentials across catalyst beds indicate the initiation of reactions within the reactor.
